(19) United States
(12) Patent Application Publication
(10) Pub. No.: US 2025/0306443 A1
(43) Pub. Date: Oct. 2, 2025

(54) LIGHTING MODULES AND PROJECTION DEVICES

(71) Applicant: Coretronic Corporation, Hsin-Chu (TW)

(72) Inventor: Sung-Lien CHEN, Hsin-Chu (TW)

(21) Appl. No.: 19/090,298

(22) Filed: Mar. 25, 2025

(30) Foreign Application Priority Data
Apr. 1, 2024 (TW) 113112311

(51) Int. Cl. G03B 21/16; G03B 21/20

(52) U.S. Cl. CPC G03B 21/16; G03B 21/208

(57) ABSTRACT

A lighting module and a projection device are disclosed. The lighting module includes a first housing, a second housing, a heat dissipation element, an elastic seal including three sealing parts, and a heat-generating component. The first housing is assembled to the second housing, an opening is formed on a first side of the assembled first housing and the second housing. The heat dissipation element covers the opening, an accommodation space accommodation space surrounded by the heat dissipation element, the first housing and the second housing. A first sealing part seals the joint between the first housing and the second housing, a second sealing part seals the joint between the first housing and the heat dissipation element, and a third sealing part seals the joint between the second housing and the heat dissipation element. The first sealing part, the second sealing part and the third sealing part are integrally formed.

### CROSS REFERENCE TO RELATED APPLICATION

This application claims the priority benefit of Taiwan Patent Application Serial Number 113112311, filed on Apr. 1, 2024, the full disclosure of which is incorporated herein by reference.

### BACKGROUND

### Technical Field

The present invention is related to the technical field of dust prevention, and in particular to a lighting module and projection device.

### Description of the Related Art

In the optical engine module of a projector, the optical engine module is assembled with a base and a cover. Then an accommodation space is created between the base and the upper cover, and the fluorescent wheel is arranged inside the accommodation space. Furthermore, a plurality of dust-proof parts are assembled in correspondence with the structure of the joints between the base and the upper cover to seal off dust or dirt from entering the accommodation space through the assembly gap between the base and the cover, thereby preventing dust or dirt from affecting the color wheel. However, because the plurality of dust-proof parts are arranged based on the structure of the joints between the cover and the base, in addition to the assembly tolerance between the cover and the base, there are also tolerance variations in the connection between adjacent dust-proof parts. As a result, no matter how many dust-proof parts are used, it is still difficult to completely seal the gaps between the cover and the base. There will be gaps between the cover, the base and the plurality of dust-proof parts due to assembly, so the dust-proof effect will also be affected.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The present invention provides a lighting module that improves the sealing and dust-proof structure between the assembled housing and structure, addressing the issue of gaps in the dust-proof structure.

The present invention further provides a projection device including the aforementioned lighting module, with improved structural reliability.

Other objectives, features and advantages of the present invention will be further understood from the further technological features disclosed by the embodiments of the present invention wherein there are shown and described preferred embodiments of this invention, simply by way of illustration of modes best suited to carry out the invention.

To achieve one or more of the above-mentioned objectives, either in part or in whole, or for other objectives, an embodiment of the present invention provides a lighting module including a first housing, a second housing, a heat dissipation element, an elastic seal component, and a heat-generating component. The first housing is assembled to the second housing and an opening is formed on a first side of the first housing and second housing after the first housing and the second housing are assembled. The heat dissipation element is assembled to and covers the opening; an accommodation space is formed and surrounded by the first housing, the second housing, and the heat dissipation element. An elastic seal component has a first sealing part, a second sealing part, and a third sealing part. The first sealing part seals the joint between the first housing and the second housing, the second sealing part seals the joint between the first housing and the heat dissipation element, the third sealing part seals the joint between the second housing and the heat dissipation element. The first sealing part, the second sealing part, and the third sealing part are integrally formed. The heat-generating component connects to the heat dissipation element and the heat-generating component is disposed inside the accommodation space.

To achieve one or more of the above-mentioned objectives, either in part or in whole, or for other objectives, an embodiment of the present invention provides a projection device including a lighting system, a light valve and a projection lens. The lighting system is employed for providing a lighting beam. The lighting system has a lighting module. The lighting module includes: a first housing, a second housing, a heat dissipation element, an elastic seal component, and a heat-generating component. The first housing is assembled to the second housing and an opening is formed on a first side of the first housing and the second housing after the first housing and the second housing are assembled. The heat dissipation element is assembled to and covers the opening. An accommodation space is formed and surrounded by the first housing, the second housing, and the heat dissipation element. The elastic seal component has a first sealing part, a second sealing part, and a third sealing part. The first sealing part seals the joint between the first housing and the second housing, the second sealing part seals the joint between the first housing and the heat dissipation element, the third sealing part seals the joint between the second housing and the heat dissipation element. The first sealing part, the second sealing part and the third sealing part are integrally formed. The heat-generating component is connected to the heat dissipation element. The heat-generating component is disposed inside the accommodation space. The light valve is disposed in a transmission path of the lighting beam for receiving the lighting beam and forming an image beam. The projection lens is disposed in the transmission path of the image beam for receiving the image beam and projecting the image beam to the outside of the projection device.

Based on the description presented above, embodiments of the present invention have at least one of the following advantages or effects. In the design of lighting module of the present invention, an integrally formed elastic seal component is assembled between the first housing, the second housing and the heat dissipation element. The elastic seal component effectively seals gaps between the first housing, the second housing, and the heat dissipation element, to avoid the impact of assembly tolerances on sealing performance, and preventing ingress of external dust into the lighting module. Consequently, it ensures that the heat-generating component, such as wavelength conversion wheel, disposed inside the accommodation space remain unaffected by dust, enabling the heat-generating component to function optimally while maintaining efficient heat dissipation. Moreover, the projection device of the present invention with the abovementioned lighting module enhances its structural reliability.

### BRIEF DESCRIPTION OF THE DRAWINGS

The accompanying drawings presented herein serve to deepen the understanding of the present application and are an integral part thereof. The illustrative embodiments and their explanations are provided to elucidate the present application and do not impose any undue limitations on it. In the drawings:

FIG. 1 is a block diagram of an embodiment of the projection device of the present invention;

FIG. 2 is a schematic diagram of an embodiment of the lighting module of the present invention;

FIG. 3 illustrates an exploded view of an embodiment of the lighting module of the present invention;

FIG. 4 illustrates another exploded view of an embodiment of the lighting module of the present invention;

FIG. 5 illustrates yet another perspective exploded view of an embodiment of the lighting module of the present invention different from FIG. 4;

FIG. 6 illustrates a side view of an embodiment of the lighting module of the present invention;

FIG. 7 illustrates a sectional view of line A-A′ of the lighting module in FIG. 6;

FIG. 8 illustrates an enlarged view of region D of the lighting module in FIG. 7;

FIG. 9 illustrates a sectional view of line B-B′ of the lighting module in FIG. 6;

FIG. 10 illustrates an enlarged view of region E of the lighting module in FIG. 9; and

FIG. 11 illustrates a sectional view of line C-C′ of the lighting module in FIG. 6.

### DETAILED DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

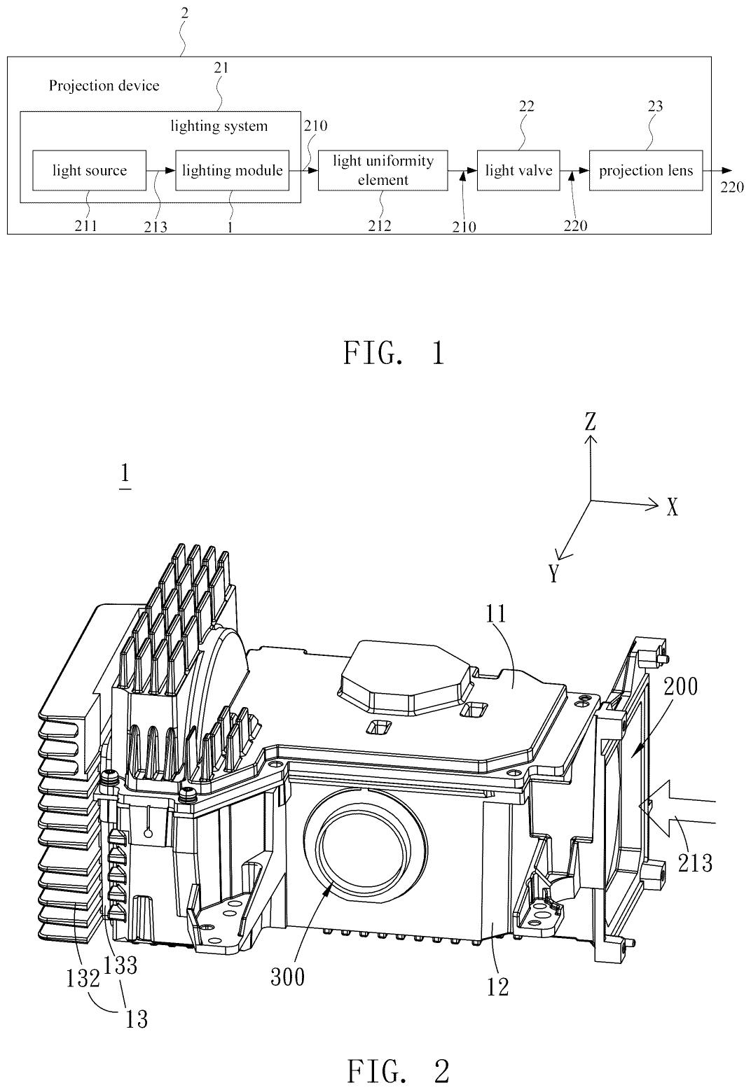

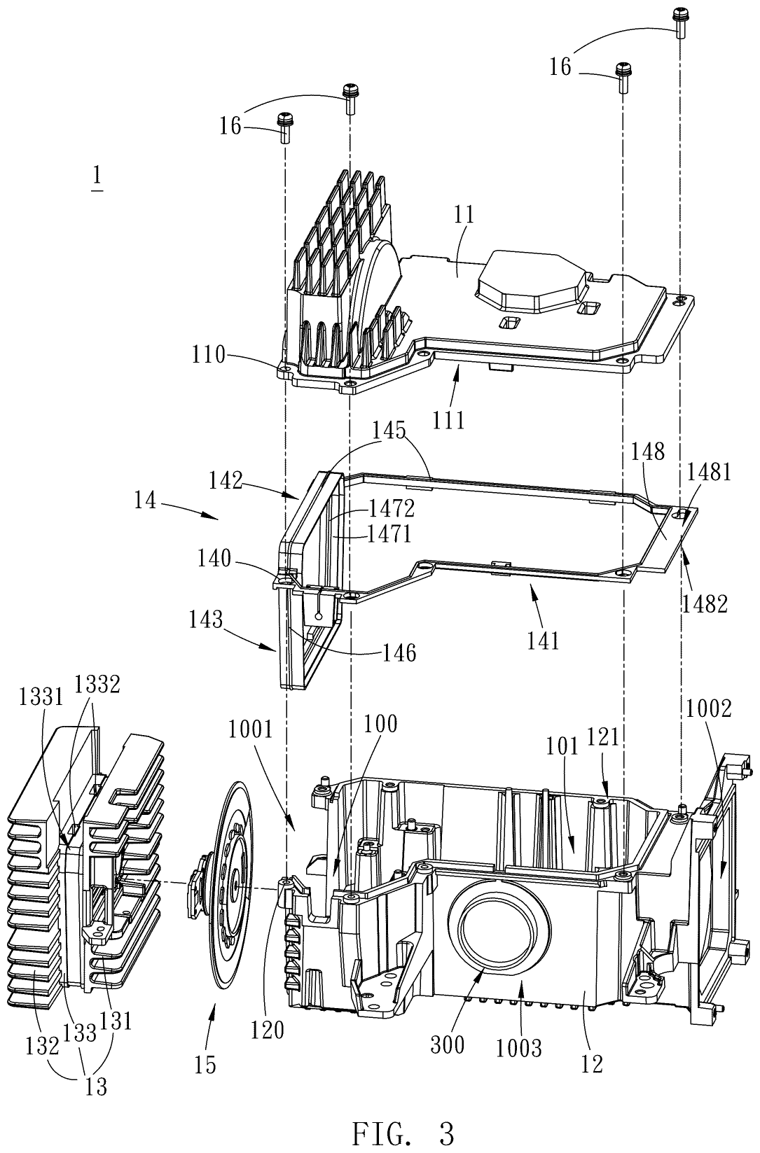

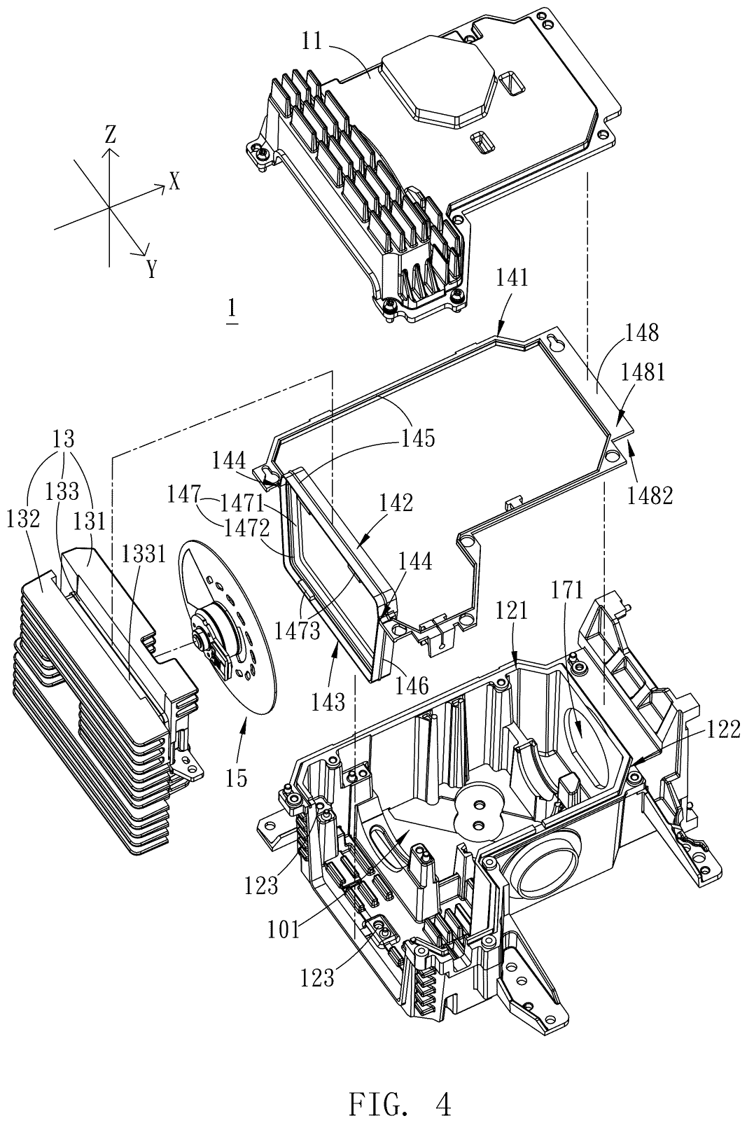

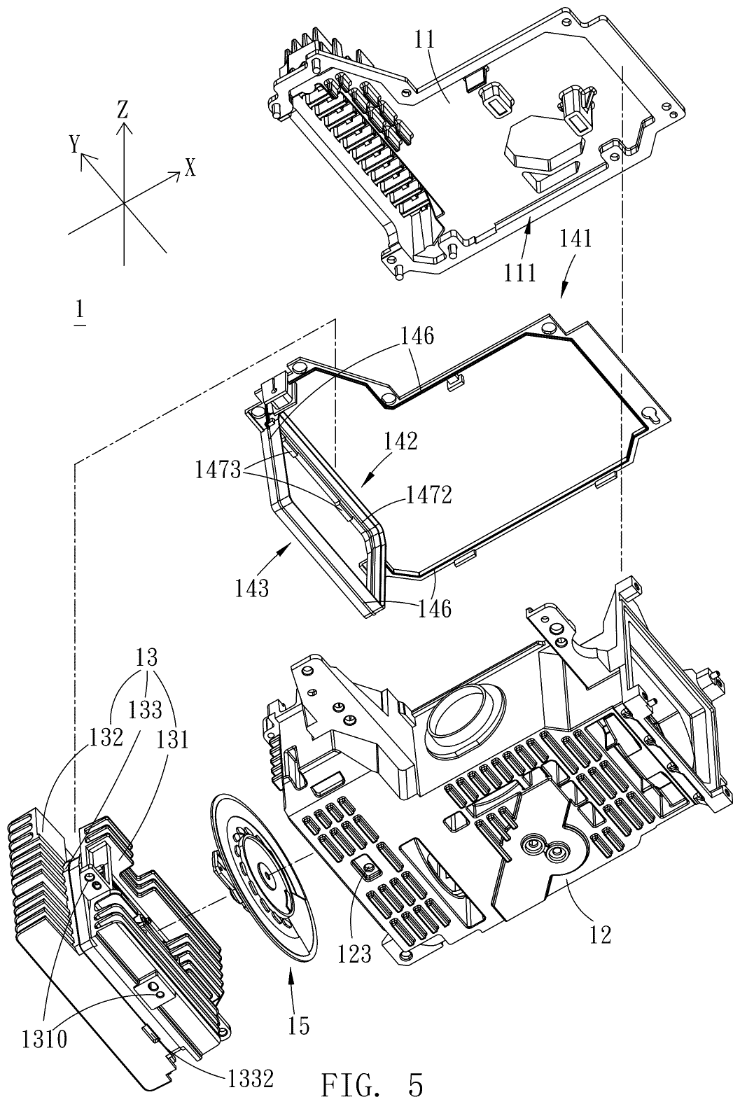

Please refer to FIG. 1 to FIG. 5, FIG. 1 is a block diagram of an embodiment of the projection device of the present invention, FIG. 2 is a schematic diagram of the lighting module, FIG. 3 is an exploded view of the lighting module, FIG. 4 is another exploded view of the lighting module and FIG. 5 is yet another perspective exploded view of an embodiment of the lighting module of the present invention different from FIG. 4. As shown in the drawings, the present invention provides a lighting module 1 including: a first housing 11, a second housing 12, a heat dissipation element 13, an elastic seal component 14, and a heat-generating component 15. The first housing 11 is assembled to the second housing 12, and after assembly, opening 100 is formed on the first side 1001 of the first housing 11 and the second housing 12. The heat dissipation element 13 is assembled to and covers the opening 100, wherein the heat dissipation element 13 in the embodiments in this invention may be a heat sink, as shown in FIGS. 2 and 3. An accommodation space 101 is formed and surrounded by the first housing 11, the second housing 12 and the heat dissipation element 13. The elastic seal component 14 has the first sealing part 141, the second sealing part 142 and the third sealing part 143. The first sealing part 141 seals the joint between the first housing 11 and the second housing 12. The second sealing part 142 seals the joint between the first housing 11 and heat dissipation element 13. The third sealing part 143 seals the joint between the second housing 12 and the heat dissipation element 13. The first sealing part 141, the second sealing part 142, and the third sealing part 143 are integrally formed. The heat-generating component 15 connects to the heat dissipation element 13 and the heat-generating component 15 is disposed inside the accommodation space 101.

In this embodiment, the assembly sequence of the lighting module 1, for example, can be presented as follows: initially, the heat-generating component 15 is assembled onto the heat dissipation element 13, followed by the placement of the second sealing part 142 and the third sealing part 143 of the elastic seal component 14 around the heat dissipation element 13. Subsequently, the above-mention assembled heat-generating component 15 and heat dissipation element 13 are mounted onto the second housing 12, wherein the heat-generating component 15 is assembled inside the second housing 12. A portion of the heat dissipation element 13 is situated inside the second housing 12 while another portion of the heat dissipation element 13 is outside the second housing 12. Simultaneously, the first sealing part 141 and the third sealing part 143 of the elastic seal component 14 are installed to the frame of the second housing 12. Finally, the first housing 11 is assembled to the heat dissipation element 13 and the second housing 12 for allowing the first sealing part 141 and the second sealing part 143 of the elastic seal component 14 to be installed to the frame of the first housing 11. Alternatively, in another embodiment, the assembly sequence of the lighting module 1 involves: the assembled heat-generating component 15 and the heat dissipation element 13 are first installed onto the first housing 11, followed by the installation of the first sealing part 141 and the second sealing part 143 of the elastic seal component 14 onto the frame of the first housing 11. Subsequently, installing the second housing 12 onto the heat dissipation element 13 and the first housing 11, with the first sealing part 141 and the second sealing part 143 of the elastic seal component 14 installed onto the frame of the first housing 11.

As described above, the lighting module 1 further includes a plurality of fixing element 16. The elastic seal component 14 further includes a plurality of through hole 140. The first housing 11 has a plurality of first fixing hole 110, the second housing 12 has a plurality of second fixing hole 120. These fixing elements 16 individually insert through the first fixing holes 110 of the first housing 11, the through holes 140 of the elastic seal component 14, and the second fixing holes 120 of the second housing 12 in sequence to fix the first housing 11, the elastic seal component 14, and the second housing 12 and allowing the first housing 11 and the second housing 12 to tightly compress the elastic seal component 14. In the assembly sequence, the heat dissipation element 13 is installed onto the opening 100 formed by the first housing 11 and the second housing 12 before these fixing elements 16 are fastened. After the aforementioned assembly, besides the opening 100 formed at the first side 1001 of the first housing 11 and the second housing 12, a second side 1002 of the first housing 11 and the second housing 12 has a beam input port 200. A third side 1003 of the first housing 11 and the second housing 12 has a beam output port 300. The first side 1001 corresponding to the opening 100 and the second side 1002 corresponding to the beam input port 200 are situated at two opposite sides of the lighting module 1. The third side 1003 corresponding to the beam output port 300 is an adjacent side surface shared by the first side 1001 and the second side 1002. In some embodiments, the lighting module 1 further includes a first optical component (not shown) and a position 171. The position 171 is adjacent to the beam input port 200 and situated at a side away from the light source 211. The first optical component can be disposed at and covers the position 171. The optical component can be such as converging lens and its structure and implementation readily understandable by those skilled in the art, thus requiring no further description.

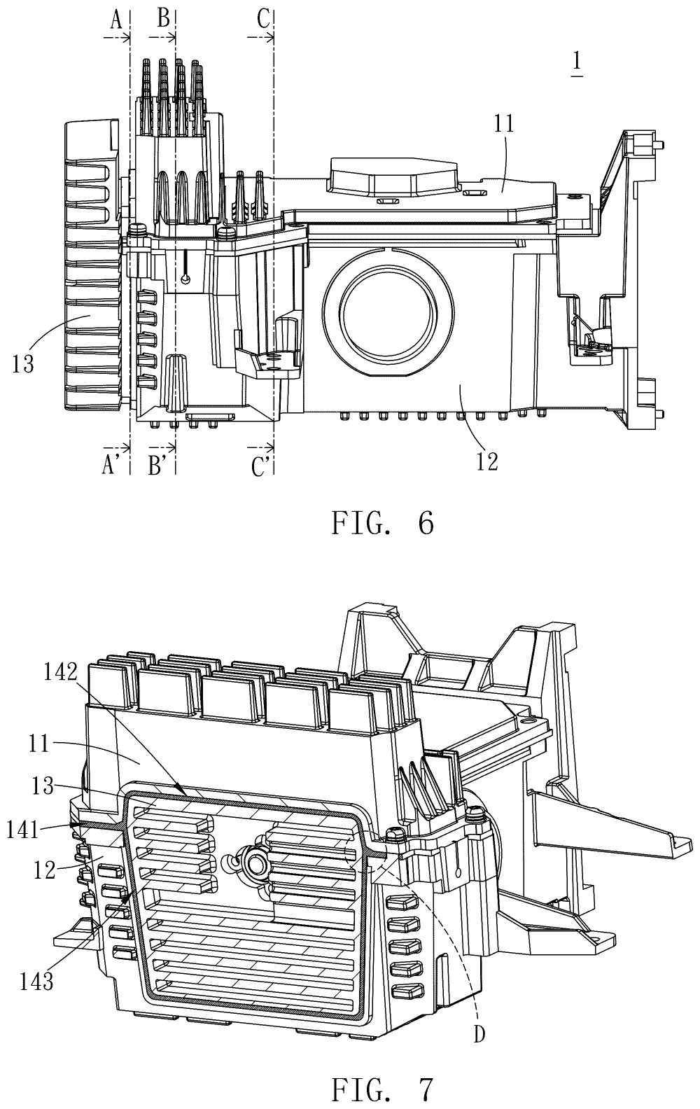

Please refer FIG. 6 to FIG. 8, FIG. 6 is a side view of an embodiment of the lighting module of the present invention, FIG. 7 is a sectional view of line A-A′ of the lighting module in FIG. 6, and FIG. 8 is an enlarged view of region D of the lighting module in FIG. 7. As shown in the drawings, the elastic seal component 14 further includes at least one elastic connecting part 144 and each of the at least one elastic connecting part 144 connects to the first sealing part 141, the second sealing part 142, and the third sealing part 143. The at least one elastic connecting part 144, the first sealing part 141, the second sealing part 142, and the third sealing part 143 are integrally formed. The at least one elastic connecting part 144 seals at least one junction 149 between the first housing 11, the second housing 12 and the heat dissipation element 13. Moreover, the first housing 11 has at least one chamfer A corresponding to at least one junction 149 between the first housing 11, the second housing 12, and the heat dissipation element 13, wherein when the first housing 11 is assembled and sealed relative to the second housing 12 and the heat dissipation element 13, the chamfer A of the first housing 11 exerts an even compressive force on the elastic connecting part 144, enabling the elastic connecting part 144 to be evenly compressed, thereby achieving effective filling of the gaps between the first housing 11, the second housing 12, and the heat dissipation element 13. In this embodiment, the chamfer A faces one side of the at least one elastic connecting part 144 and the chamfer A can be a fillet or non-fillet.

As described above, in this embodiment, the first sealing part 141 has a thickness along the assembly direction of the first housing 11 and the second housing 12, the thickness of the assembly direction of the first sealing part 141 is the thickness in the Z-axis (please refer to FIG. 4). The second sealing part 142 has a thickness along the assembly direction of the first housing 11 and the heat dissipation element 13, the thickness of the assembly direction of the second sealing part 142 includes a partial thickness in the Z-axis direction and a partial thickness in the Y-axis direction (please refer to FIG. 4). The third sealing part 143 has a thickness along the assembly direction of the second housing 12 and the heat dissipation element 13, the thickness of the assembly direction of the third sealing part 143 includes a partial thickness in the Z-axis direction and a partial thickness in the Y-axis direction (please refer to FIG. 4). In this embodiment, there are two at least one elastic connecting part 144, the thickness TO of the at least one elastic connecting part 144 is greater than the thickness T1 of the first sealing part 141, the thickness T2 of the second sealing part 142, or the thickness T3 of the third sealing part 143. Preferably, the thickness TO of the at least one elastic connecting part 144 is greater than or equal to twice thickness T1 of the first sealing part 141, the thickness T2 of the second sealing part 142, and the thickness T3 of the third sealing part 143 respectively. In this embodiment, due to the higher stress intensity subjected to the junction 149 of the strictures of the first housing 11, the second housing 12, and the heat dissipation element 13 during assembly or pulling, the thickness of the elastic connecting part 144 at the junction 149 is configured to be greater than the thickness T1 of the first sealing part 141, the thickness T2 of the second sealing part 142, and the thickness T3 of the third sealing part 143, for enhancing the structural strength of the elastic connecting part 144 to prevent structural failure of the elastic seal component 14.

Please refer to FIG. 3 to FIG. 5, the heat dissipation element 13 further includes a first heat dissipation body 131, a heat dissipation element connecting part 133, and a second heat dissipation body 132. The heat dissipation element connecting part 133 situates between the first heat dissipation body 131 and the second heat dissipation body 132. The heat dissipation element 13 is disposed at the opening 100 formed after the first housing 11 and the second housing 12 were assembled. The first heat dissipation body 131 situates inside the accommodation space 101, the second heat dissipation body 132 situates outside the accommodation space 101. The heat dissipation element connecting part 133 is surrounded by the inner wall of the opening 100. The second sealing part 142 and the third sealing part 143 surround the outer wall 1331 of the heat dissipation element connecting part 133. The second sealing part 142 situates between the heat dissipation element connecting part 133 and the first housing 11. The third sealing part 143 situates between the heat dissipation element connecting part 133 and the second housing 12. In this embodiment, both the first heat dissipation body 131 and the second heat dissipation body 132 feature structures with heat dissipation fin. The first heat dissipation body 131, the heat dissipation element connecting part 133, and the second heat dissipation body 132 can be an integrally formed structure. In some embodiments, the first heat dissipation body 131, the heat dissipation element connecting part 133, and the second heat dissipation body 132 can also constitute a structure formed through assembly methods, rather than being limited to an integrally molded structure.

In another embodiment, there are two junction 149 situated between the first housing 11, the second housing 12 and the heat dissipation element 13. The elastic seal component 14 has two elastic connecting part 144 corresponding to the two junction 149. During assembly, the second sealing part 142, the third sealing part 143, and the two elastic connecting part 144 completely surround the outer wall 1331 of the heat dissipation element connecting part 133.

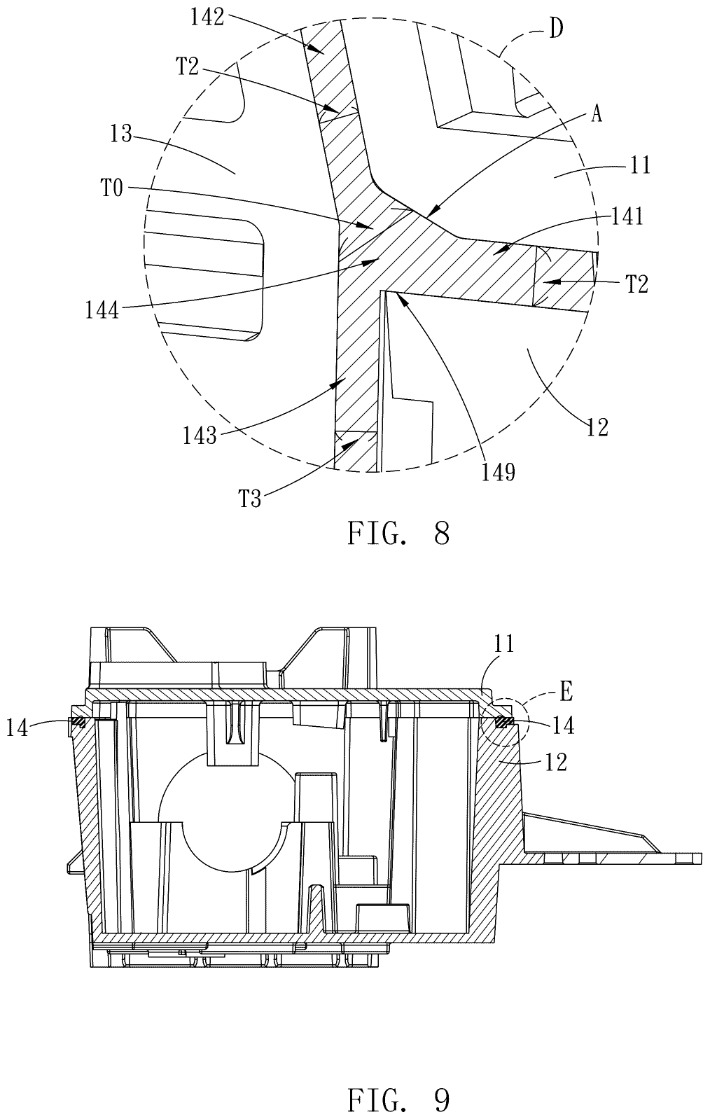

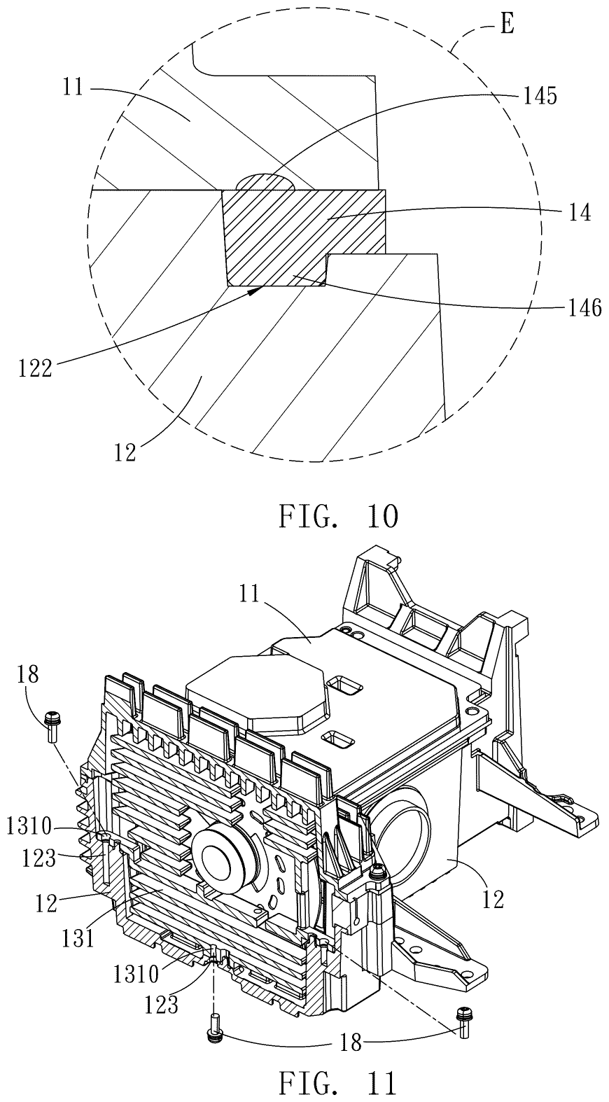

FIG. 9 is a sectional view of line B-B′ of the lighting module in FIG. 6. FIG. 10 is an enlarged view of region E of the lighting module in FIG. 9. Please refer to FIG. 9 and FIG. 10, in conjunction with FIG. 3 to FIG. 5. In this embodiment, the first housing 11 has a first assembly surface 111 facing the second housing 12. The first assembly surface 111, for example, is a continuous surface on the frame of the first housing 11 facing second housing 12. The second housing 12 has a second assembly surface 121 facing the first housing 11. The second assembly surface 121, for example, is a continuous surface on the frame of the second housing 12 facing first housing 11. After assembly, the elastic seal component 14 situates between the first assembly surface 111 and the second assembly surface 121. The elastic seal component 14 includes a first convex strip 145 and a second convex strip 146. The first convex strip 145 is continuously disposed on the elastic seal component 14 along the surface of the first sealing part 141 facing the first housing 11, along the surface of the second sealing part 142 facing the first housing 11, and along the surface of the at least one elastic connecting part 144 facing the first housing 11. The first convex strip 145 abuts the first assembly surface 111 of the first housing 11. The second convex strip 146 is continuously disposed on the elastic seal component 14 along the surface of the first sealing part 141 facing the second housing 12, along the surface of the third sealing part 143 facing the second housing 12, and along the surface of the at least one elastic connecting part 144 facing the facing second housing 12. The second convex strip 146 abuts the second assembly surface 121 of the second housing 12. This configuration enhances the sealing strength of the lighting module 1 through the first convex strip 145 being against the first housing 11, the second convex strip 146 being against the second housing 12.

As described above, in this embodiment, the second housing 12 has a recess 122 situated on the second assembly surface 121 corresponding to embedding with the second convex strip 146. In other words, the second assembly surface 121 of the second housing 12 has recess 122, the second convex strip 146 of the elastic seal component 14 is embedded within recess 122, to enhance the structural bonding strength between the elastic seal component 14 and the second housing 12. Meanwhile, the contact area that the elastic seal component 14 abuts the second housing 12 is also increased, thereby extending the path length for external dust particles to enter the accommodation space 101 from the outside of the second housing 12. Consequently, it effectively prevents external dust from entering the accommodating space 101. Moreover, the present invention does not limit the first housing 11 having a recess (not shown) on the first assembly surface 111 corresponding to embedding with the first convex strip 145, for achieving the same effect as the combination of the second convex strip 146 with the recess 122. Further description is omitted.

Please refer FIG. 3 to FIG. 5, for further description, the elastic seal component 14 includes a protruding structure 147. The protruding structure 147 includes a protruding piece 1471 and a third convex strip 1472. Both the protruding piece 1471 and the third convex strip 1472 are continuously disposed on the elastic seal component 14 along the surface of the second sealing part 142 facing the heat dissipation element connecting part 133 and along the surface of the third sealing part 143 facing the heat dissipation element connecting part 133. The third convex strip 1472 abuts the outer wall 1331 of the heat dissipation element connecting part 133, the third convex strip 1472 is disposed on the protruding piece 1471; i.e., the third convex strip 1472 is protruding from the surface of the protruding piece 1471. The protruding structure 147 abuts the outer wall 1331 of the heat dissipation element connecting part 133; i.e., the second sealing part 142 and the third sealing part 143 has an inner wall (non-labeled) corresponding to the outer wall 1331 of the heat dissipation element connecting part 133. The protruding structure 147 is disposed on the inner wall of the second sealing part 142 and the third sealing part 143, wherein in the direction the inner wall facing the outer wall 1331 of the heat dissipation element connecting part 133, the thickness of the third convex strip 1472 relative to the inner wall is greater than the thickness of the protruding piece 1471 relative to the inner wall. In addition, the outer wall 1331 of the heat dissipation element connecting part 133 has a groove (non-labeled surround the outer wall. The protruding piece 1471 and the third convex strip 1472 are correspondingly embedded in the groove of the outer wall 1331. In other words, the protruding piece 1471 and the third convex strip 1472 are employed for effectively positioning the elastic seal component 14 on the heat dissipation element connecting part 133. The sealing strength of the second sealing part 142 and the third sealing part 143 of the elastic seal component 14 to the heat dissipation element connecting part 133 of the heat dissipation element 13 can be strengthened accordingly. Moreover, the present invention does not limit the heat dissipation element connecting part 133 has a recess (not shown) at the groove of the outer wall 1331 corresponding to embedded with the third convex strip 1472, for achieving the same effect as the embedding of the second convex strip 146 into the recess 122, further description is omitted.

As described above, the protruding structure 147 further includes a plurality of bump 1473. The plurality of bump 1473 locates on the surface of the second sealing part 142 facing the heat dissipation element connecting part 133 and the surface of the third sealing part 143 facing heat dissipation element connecting part 133, for example, a plurality of bump 1473 are disposed on the inner wall of the second sealing part 142 and the third sealing part 143 with internal. The plurality of bump 1473 situates on side surface of the protruding piece 1471 and third convex strip 1472. The heat dissipation element connecting part 133 further includes a plurality of notch 1332. The plurality of notch 1332 locates at the outer wall 1331 of the heat dissipation element connecting part 133. The plurality of notch 1332 correspond to the positions of the plurality of bump 1473. The plurality of bump 1473 are embedded within the corresponding the plurality of notch 1332. This reinforcement enhances the secure fixation of the second sealing part 142 and third sealing part 143 of the elastic seal component 14 to the heat dissipation element connecting part 133 of the heat dissipation element 13.

Please refer to FIG. 4, the elastic seal component 14 further includes an extended portion 148. The extended portion 148 extends from the outer side surface of the first sealing part 141 in a direction away from the heat dissipation element 13. The extended portion 148 has a first extended surface 1481 and a second extended surface 1482, the first housing 11 abuts the first extended surface 1481 after assembly, the second housing 12 abut the second extended surface 1482 after assembly. In this embodiment, the extended portion 148 is employed to increase the contact area between the elastic seal component 14 relative to the first assembly surface 111 of the first housing 11 and the second assembly surface 121 of the second housing 12. Simultaneously, the path length for entering the accommodation space 101 from the outside the first housing 11 and the second housing 12 is extended, thereby aiding in the prevention of dust from entering the accommodating space 101.

FIG. 11 is a sectional view of line C-C′ of the lighting module in FIG. 6. Please refer to FIG. 11 in conjunction with FIG. 3 to FIG. 5, in this embodiment, the lighting module 1 further includes a plurality of fastening element 18. The second housing 12 has a plurality of first fastening hole 123. The heat-generating component 15 is fixed to the first heat dissipation body 131. The first heat dissipation body 131 has a plurality of second fastening hole 1310. These first fastening holes 123 and these second fastening holes 1310 correspond to each other. These fastening elements 18 individually insert through and fastening to these second fastening holes 1310 of the first heat dissipation body 131 and these first fastening holes 123 of the second housing 11. The positions of these first fastening holes 123 and these second fastening holes 1310 present a straight line in the orthogonal projection onto the bottom surface of the second housing 11 (as shown in FIG. 5, the bottom surface is parallel to the XY plane). This positioning method reduces the motor swing of the heat-generating component 15, thereby reducing the noise generated when the heat-generating component 15 operates. It is noted that, the fastening element 18 in this embodiment and the above-mentioned fixing element 16 can be the same type of component, such as screws, however, the present invention is not limiting to this embodiment.

In this embodiment, the heat-generating component 15 includes a wavelength conversion wheel, such as a fluorescent wheel. There are three first fastening holes 123, wherein one of the first fastening hole 123 locates on the bottom surface of the second housing 12, the other two first fastening holes 123 locate on a side surface of the second housing 12.

Please refer FIG. 1 to FIG. 5, the present embodiment provides a projection device 2 with a lighting system 21, a light valve 22 and a projection lens 23. The lighting system 21 provides lighting beam 210. The lighting system 21 has a lighting module 1, the lighting module 1 includes: a first housing 11, a second housing 12, a heat dissipation element 13, an elastic seal component 14 and a heat-generating component 15. The first housing 11 is assembled to the second housing 12, after assembly, opening 100 is formed on a first side of the first housing 11 and the second housing 12. The heat dissipation element 13 is assembled to and covers the opening 100. An accommodation space 101 is formed and surrounded by the heat dissipation element 13, the first housing 11 and the second housing 12. The elastic seal component 14 has a first sealing part 141, a second sealing part 142 and a third sealing part 143. The first sealing part 141 seals the joint between the first housing 11 and the second housing 12. The second sealing part 142 seals the joint between the first housing 11 and the heat dissipation element 13. The third sealing part 143 seals the joint between the second housing 12 and the heat dissipation element 13. The first sealing part 141, the second sealing part 142, and the third sealing part 143 are integrally formed. The heat-generating component 15 connects to the heat dissipation element 13, the heat-generating component 15 is disposed inside the accommodation space 101. The light valve 22 is disposed in a transmission path of the lighting beam 210 for receiving the lighting beam 210 and forming an image beam 220. The projection lens 23 is disposed in a transmission path of the image beam 220 for receiving image beam 220, and projecting the image beam 220 to the outside of projection device 23. In this embodiment, the lighting system 21 further includes a light source 211. The light source 211 is corresponding to the beam input port 200. Further, the projection device 2 further includes a light uniformity element 212, the light uniformity element 212 is corresponding to the beam output port 300. The lighting system 21 is applied for providing the lighting beam 210. It is noted that, in this embodiment, the beam 213 provided by the light source 211 passes through the first optical component at position 171 and then entering the lighting module 1. The light uniformity element 212 is disposed at and covers the beam output port 300. Thus, a projection device 2 with lighting module1 is provided, offering excellent structural reliability and dust-proof effectiveness. In this embodiment, the light source 211, for example, is composed of a plurality of light-emitting elements, such as LED (Light Emitting Diode) or LD (Laser Diode). The light uniformity element, for example, is an integrating rod (Rod). The light valve 22 for example, is DMD (Digital Micro-mirror Device), or optionally a reflective light modulator such as a LCOS panel (Liquid Crystal On Silicon panel). The projection lens 23 for example, is a combination of one or more optical lenses with refractive power, such as various combinations of non-planar lenses such as biconcave lenses, biconvex lenses, meniscus lenses, convex-concave lenses, plano-convex lenses, and plano-concave lenses. The structure and implementation of the light source 211, the light uniformity element 212, the light valve 22, and the projection lens 23 of the present invention can be adequately taught by common knowledge in the technical field, and therefore will not be described again.

In summary, embodiments of the present invention have at least one of the following advantages or effects. In the design of the lighting module of the present invention, an integrally formed elastic seal component is assembled between the first housing, the second housing and the heat dissipation element. The elastic seal component completely seals the gaps between the first housing, the second housing and the heat dissipation element, thereby avoiding the impact of assembly tolerances on the sealing effect and preventing external dust from entering the lighting module. This ensures that heat-generating components (such as wavelength conversion wheels) arranged in the accommodating space are not affected by dust, allowing the heat-generating components to function properly and providing effective heat dissipation. Additionally, the projection device using the lighting module of the present invention can have better structural reliability.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present invention is intended to be dedicated to the public regardless of whether the element or component is explicitly recited in the following claims.

What is claimed is:

1. A lighting module, comprising:
a first housing;
a second housing, wherein the first housing is assembled to the second housing, and an opening is formed on a first side of the first housing and the second housing after the first housing and the second housing are assembled;
a heat dissipation element assembled to and covering the opening, wherein an accommodation space is formed and surrounded by the heat dissipation element, the first housing and the second housing;
an elastic seal component having a first sealing part, a second sealing part and a third sealing part, wherein the first sealing part seals a joint between the first housing and the second housing, the second sealing part seals a joint between the first housing and the heat dissipation element, the third sealing part seals a joint between the second housing and the heat dissipation element, wherein the first sealing part, the second sealing part and the third sealing part are integrally formed; and
a heat-generating component connected to the heat dissipation element, the heat-generating component disposed inside the accommodation space.

2. The lighting module as claimed in claim 1, wherein the elastic seal component further comprises at least one elastic connecting part, each of the at least one elastic connecting part connected to the first sealing part, the second sealing part and the third sealing part, wherein the at least one elastic connecting part, the first sealing part, the second sealing part and the third sealing part are integrally formed, the at least one elastic connecting part seals at least one junction between the first housing, the second housing and the heat dissipation element.

3. The lighting module as claimed in claim 2, wherein the first sealing part has a thickness along an assembly direction of the first housing and the second housing, the second sealing part has the thickness along the assembly direction of the first housing and the heat dissipation element, the third sealing part has the thickness along the assembly direction of the second housing and the heat dissipation element, wherein the thickness of each of the at least one elastic connecting part is greater than the thickness of the first sealing part, the thickness of the second sealing part or the thickness of the third sealing part.

4. The lighting module as claimed in claim 3, wherein the thickness of the at least one elastic connecting part is greater than or equal to twice the thickness of the first sealing part, the thickness of the second sealing part and the thickness of the third sealing part respectively.

5. The lighting module as claimed in claim 1, wherein there is at least one junction between the first housing, the second housing and the heat dissipation element, and the first housing has at least one chamfer corresponding to the at least one junction.

6. The lighting module as claimed in claim 2, wherein the heat dissipation element further comprises a first heat dissipation body, a heat dissipation element connecting part and a second heat dissipation body, wherein the heat dissipation element connecting part is situated between the first heat dissipation body and the second heat dissipation body, the heat dissipation element is disposed at the opening formed after the first housing and the second housing are assembled, the first heat dissipation body is situated inside the accommodation space, the second heat dissipation body is situated outside the accommodation space, the heat dissipation element connecting part is surrounded by an inner wall of the opening.

7. The lighting module as claimed in claim 6, wherein:
the second sealing part and the third sealing part surround an outer wall of the heat dissipation element connecting part,
the second sealing part is situated between the heat dissipation element connecting part and the first housing, and
the third sealing part is situated between the heat dissipation element connecting part and the second housing.

8. The lighting module as claimed in claim 7, wherein:
the first housing has a first assembly surface facing the second housing,
the second housing has a second assembly surface facing the first housing, and
after the first housing and the second housing are assembled, the elastic seal component is situated between the first assembly surface and the second assembly surface; the elastic seal component comprises a first convex strip and a second convex strip, wherein:
the first convex strip continuously disposed on the elastic seal component along the surface of the first sealing part facing the first housing, along the surface of the second sealing part facing the first housing, and along the surface of the at least one elastic connecting part facing the first housing and abut the first assembly surface,
the second convex strip continuously disposed on the elastic seal component along the surface of the first sealing part facing the second housing, along the surface of the third sealing part facing the second housing, and along the surface of the at least one elastic connecting part facing the second housing and abutted the second assembly surface.

9. The lighting module as claimed in claim 8, wherein the elastic seal component comprises a third convex strip, the third convex strip continuously disposed on the elastic seal component along the surface of the second sealing part facing the heat dissipation element connecting part and along the surface of the third sealing part facing the heat dissipation element connecting part and abutted the outer wall of the heat dissipation element connecting part.

10. The lighting module as claimed in claim 9, wherein the second housing has a recess situated on the second assembly surface and corresponding to the second convex strip.

11. The lighting module as claimed in claim 6, further comprising a plurality of fastening elements, wherein:
the second housing has a plurality of first fastening hole,
the heat-generating component is fixed to the first heat dissipation body,
the first heat dissipation body has a plurality of second fastening holes,
the first fastening holes are correspond to the second fastening holes, and
the fastening elements fasten the first fastening holes and the second fastening holes,
wherein positions of the first fastening holes and the second fastening holes present a straight line in the orthogonal projection onto the bottom surface of the second housing.

12. The lighting module as claimed in claim 1, wherein the elastic seal component further comprises an extended portion, the extended portion extends from an outer side surface of the first sealing part along a direction away from the heat dissipation element, the extended portion has a first extended surface and a second extended surface, wherein after the first housing and the second housing are assembled, the first housing abuts the first extended surface and the second housing abuts the second extended surface.

13. The lighting module as claimed in claim 1, further comprising a plurality of fixing elements, wherein:
the elastic seal component further comprises a plurality of through holes,
the first housing has a plurality of first fixing holes,
the second housing has a plurality of second fixing holes,
the fixing elements are inserted through the first fixing holes, the through holes and the second fixing holes in sequence to fix the first housing, the elastic seal component and the second housing.

14. The lighting module as claimed in claim 1, wherein the heat-generating component comprises a wavelength conversion wheel.

15. The lighting module as claimed in claim 1, wherein after assembly, a second side of the first housing and the second housing has a beam input port and a third side of the first housing and the second housing has a beam output port.

16. A projection device, comprising:
a lighting system, for providing a lighting beam, the lighting system has a lighting module, the lighting module comprising;
a first housing;
a second housing, the first housing assembled to the first housing, and an opening formed on a first side of the first housing and the second housing after the first housing and the second housing are assembled;
a heat dissipation element, assembled to and covering the opening, wherein an accommodation space is formed and surrounded by the heat dissipation element, the first housing and the second housing;
an elastic seal component, having a first sealing part, a second sealing part, and a third sealing part, wherein the first sealing part seals a joint between the first housing and the second housing, the second sealing part seals the joint between the first housing and the heat dissipation element, the third sealing part seals the joint between the second housing and the heat dissipation element, the first sealing part, the second sealing part and the third sealing part are integrally formed; and
a heat-generating component, connected to the heat dissipation element, the heat-generating component disposed inside the accommodation space;
a light valve, disposed in a transmission path of the lighting beam, for receiving the lighting beam and forming an image beam; and
a projection lens, disposed in the transmission path of the image beam, for receiving the image beam and projecting the image beam to the outside of the projection device.

17. The projection device as claimed in claim 16, wherein after the first housing and the second housing are assembled, a second side of the first housing and the second housing has a beam input port and a third side of the first housing and the second housing has a beam output port.

18. The projection device as claimed in claim 17, the lighting system further comprising a light source, the light source corresponding to the beam input port.

19. The projection device as claimed in claim 17, further comprising a light uniformity element corresponding to the beam output port.
